(19) United States
(12) Patent Application Publication
(10) Pub. No.: US 2013/0199545 A1
(43) Pub. Date: Aug. 8, 2013

(54) Mouth Guard

(71) Applicant: Peter John Burns, Rose Bay (AU)

(72) Inventor: Peter John Burns, Rose Bay (AU)

(21) Appl. No.: 13/701,967

(22) PCT Filed: Jun. 21, 2011
(86) PCT No.: PCT/AU11/00750

§ 371 Date: Feb. 27, 2013

(30) Foreign Application Priority Data
Jun. 25, 2010 (AU) 2010902826

(51) Int. Cl. A61C 5/14

(52) U.S. Cl. CPC A61C 5/14
USPC 128/861

(57) ABSTRACT

A mouth guard having a “C” shape is provided with a forward portion and a pair of rearwardly extending arms. The mouth guard includes a body that provides flanges as well as a base. Rear shields are embedded in the base portions of the arms, and the shields are preferably of a corrugated configuration so as to have ridges separated by troughs.

### TECHNICAL FIELD

The present invention relates to mouth guards and more particularly, but not exclusively to mouth guards used by sports participants.

### BACKGROUND OF THE INVENTION

Mouth guards have consisted of a number of types, including those constructed of thermo-plastics material, which are heated (typically in hot water) and then applied to the user's mouth so that the mouth guard is moulded to fit the user's teeth and jaw. A more expensive type of mouth guard (custom fitted) is that provided generally by dentists. The “custom fitted” mouth guards are manufactured from an impression taken of the user's teeth and jaw. Plastics material is then applied to the mould generated from the impression. More recently, laminated pressure mouth guards have been made available.

Previous mouth guards are also described in International Patent Applications PCT/AU99/00458 and PCT/AU00/01166.

At least some of the above described mouth guards have the disadvantage that they can transmit almost entirely an impact to the user's teeth and jaw.

### OBJECT OF THE INVENTION

It is the object of the present invention to overcome or substantially ameliorate the above disadvantage.

### SUMMARY OF THE INVENTION

There is disclosed herein a mouth guard of “C-shaped” configuration so as to provide a front portion and two arms diverting rearwardly from the front portion, the front portion and both arms being generally of a “U-shaped” transverse cross section so as to provide an inner flange and an outer flange joined by a base, each arm therefore having a portion of the base, a portion inner flange and of the outer flange; and

a pair of shields, each shield being embedded in a respective one of the arm base portions, each shield being formed of resilient material so as to be deformed upon a compression force being applied thereto.

Preferably, each shield is corrugated so as to have sequentially arranged ridges and troughs.

Preferably, the ridges and troughs extend transverse relative to the arms.

Preferably, a bridge is attached to the shields so as to extend therebetween.

Preferably, the bridge is embedded in the inner flange.

Preferably, the mouth guard has a body within which the shields are embedded, and wherein the shields are formed of a material less resilient than material forming the body.

Preferably, the shields are formed of nylon or a polyamide.

Preferably, the body is formed of a vinyl containing polydimethylsiloxane.

In an alternative preferred form, the body is formed of an EVA copolymer.

Preferably, the shields are rear shields, and said mouth guard includes a labial shield embedded in the forward portion of the outer flange.

Preferably, the labial shield is joined to the rear shields.

Preferably, said bridge is a first bridge, and said mouth guard includes a second bridge, the second bridge being attached to the rear shields.

Preferably the second bridge extends at least partly along the forward base portion.

Preferably, each arm has a longitudinal length, with each rear shield extending at least 50% of the longitudinal length of the respective arm.

### BRIEF DESCRIPTION OF THE DRAWINGS

Preferred forms of the present invention will now be described by way of example with reference to the accompanying drawings wherein:

FIG. 1 is a schematic isometric view of a mouth guard incorporating shields;

FIG. 2 is a schematic side elevation of a shield employed in a mouth guard of FIG. 1;

FIG. 3. is a schematic bottom plan view of the mouth guard of FIG. 1;

FIG. 4 is a schematic sectioned side elevation of the mouth guard as shown in FIG. 3 sectioned along the line 4-4;

FIG. 5 is a schematic rear elevation of the mouth guard of FIG. 1; and

FIG. 6 is a schematic front elevation of the mouth guard of FIG. 1.

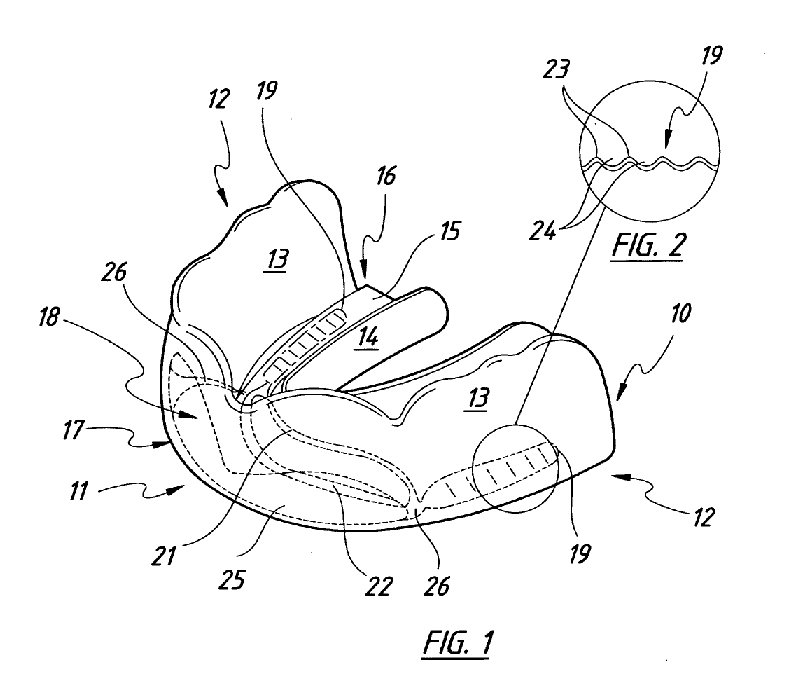

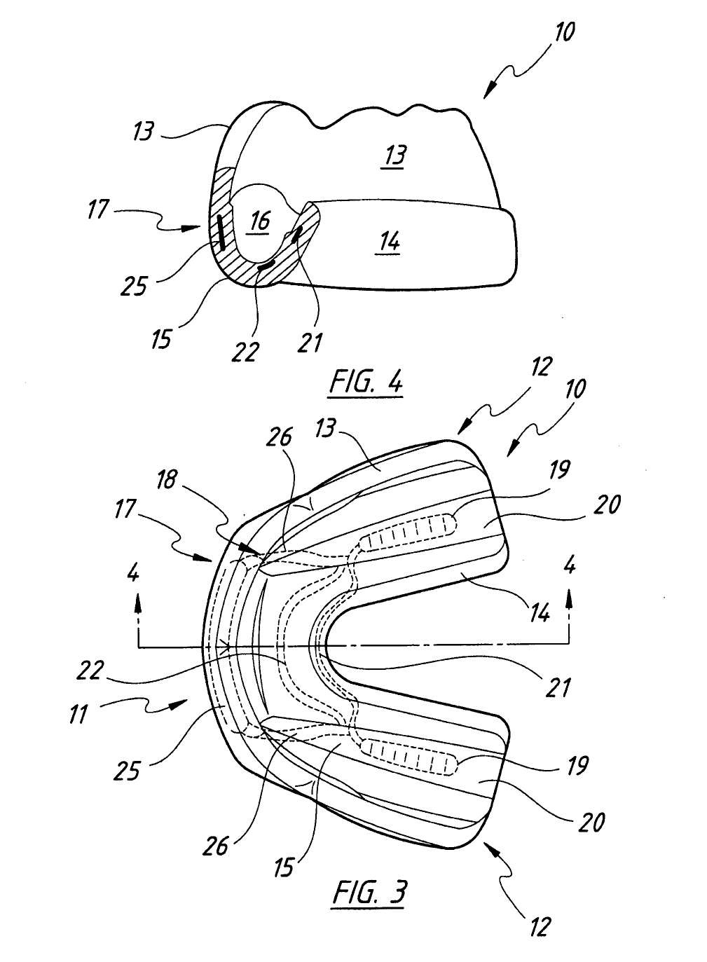

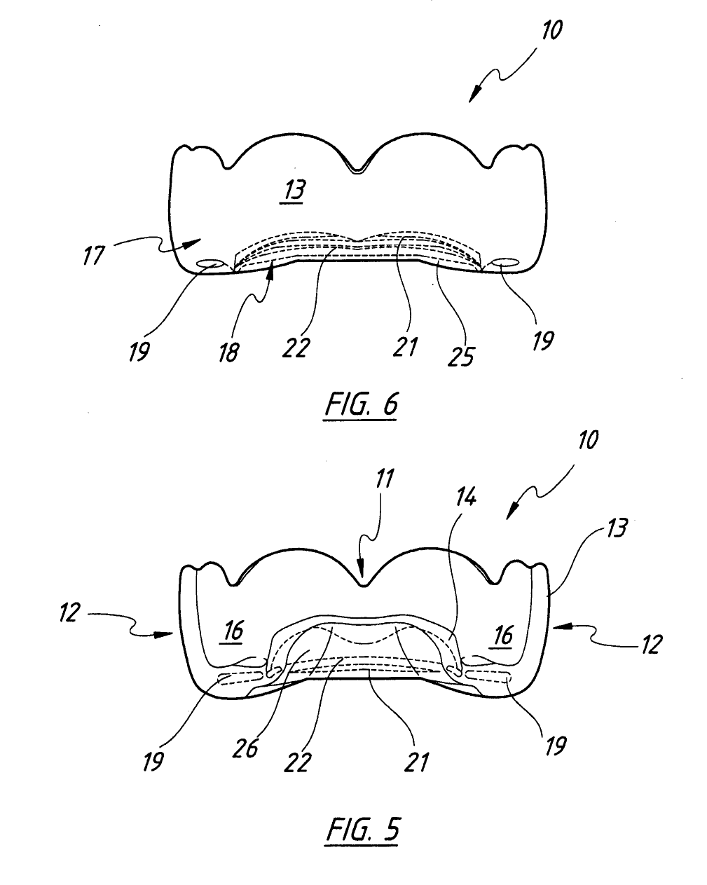

### DETAILED DESCRIPTION OF THE PREFERRED EMBODIMENTS

In the accompanying drawings there is schematically depicted a mouth guard 10. The mouth guard 10 is of an overall “C” shape so as to provide a forward portion 11 and two rearwardly extending arms 12. In transverse cross section, the portion 11, and the arms 12 are each of a U-shaped configuration as best seen in FIG. 4 so that the mouth guard 10 has an outer flange 13 joined to an inner flange 14 by a base 15. Between the flanges 13 and 14 is a trough 16 into which a wearer's teeth project.

The mouth guard 10 may be a mouth guard as described in International Patent Applications PCT/AU99/00485 and PCT/AU00/01166.

The mouth guard 10 has a body 17 that provides the flanges 13 and 14 as well as the base 15. Embedded in the body 11 is a shield member 18. The shield member 18 includes a pair of rear shields 19 that are embedded in the base portions 20 of the arms 12. The members 19 are integrally moulded with a rear bridge 21 that is at least partly located in a forward portion of the inner flange 14, and a forward bridge 22 that is located in a forward portion of the base 15.

Preferably the shields 19 are of a corrugated configuration so as to have ridges 23 separated by troughs 24, with the ridges 23 and troughs 24 extending generally transverse relative to the arms 12.

Preferably the shield member 18 further includes a forward (labial) shield 25 that is joined to the shields 19 by bridges 26.

Preferably the shield member 18 is formed of material that is less resilient than material forming the body 11. Accordingly should the wearer be subject to an impact, the shields 19 either elastically or plastically deform resulting from deformation of the body 11. The deformation of the shields 19 being flattening of the corrugations (ridges 23 and troughs 24).

Each arm 11 has a longitudinal length extending in the direction of the arms 12, with the shields 19 occupying at least 50% of the length of each arm 12.

Preferably, the shields 19 are formed of nylon or a polyamide.

Preferably, the body 17 is moulded of a vinyl containing polydimethylsiloxane.

In an alternative preferred form, the body is formed of an EVA copolymer.

Preferably, the bridge member 18 is moulded, and the body 17 subsequently moulded around the bridge member.

1. A mouth guard comprising:
a C-shaped configuration with a front portion and two arms diverting rearwardly from the front portion, the front portion and both arms being generally of a U-shaped transverse cross section having an inner flange and an outer flange joined by a base, each arm therefore having a portion of the base, a portion inner flange and of the outer flange; and
a pair of shields, each shield being embedded in a respective one of the arm base portions, each shield being formed of resilient material so as to be deformed upon a compression force being applied thereto.

2. The mouth guard of claim 1, wherein each shield is corrugated so as to have sequentially arranged ridges and troughs.

3. The mouth guard of claim 2, wherein the ridges and troughs extend transverse relative to the arms.

4. The mouth guard of claim 1, wherein a bridge is attached to the shields so as to extend therebetween.

5. The mouth guard of claim 4, wherein the bridge is embedded in the inner flange.

6. The mouth guard of claim 1, wherein the mouth guard has a body within which the shields are embedded, and wherein the shields are formed of a material less resilient than material forming the body.

7. The mouth guard of claim 6, wherein the shields are formed of nylon or a polyamide.

8. The mouth guard of claim 6, wherein the body is formed of a vinyl containing polydimethylsiloxane.

9. The mouth guard of claim 6, wherein the body is formed of an EVA copolymer.

10. The mouth guard of claim 1, wherein the shields are rear shields, and said mouth guard includes a labial shield embedded in the forward portion of the outer flange.

11. The mouth guard of claim 10, wherein the labial shield is joined to the rear shields.

12. The mouth guard of claim 11, and further comprising a bridge that is attached to the shields so as to extend therebetween, wherein said bridge is a first bridge, and said mouth guard includes a second bridge, the second bridge being attached to the rear shields.

13. The mouth guard of claim 12, wherein the second bridge extends at least partly along the forward base portion.

14. The mouth guard of claim 10, wherein each arm has a longitudinal length, with each rear shield extending at least 50% of the longitudinal length of the respective arm.

15. The mouth guard of claim 2, wherein a bridge is attached to the shields so as to extend therebetween.

16. The mouth guard of claim 4, wherein the bridge is embedded in the inner flange.

17. The mouth guard of claim 2, wherein the mouth guard has a body within which the shields are embedded, and wherein the shields are formed of a material less resilient than material forming the body.

18. The mouth guard of claim 17, wherein the shields are rear shields, and said mouth guard includes a labial shield embedded in the forward portion of the outer flange.

19. The mouth guard of claim 4, wherein the bridge is embedded in the inner flange, the shields are rear shields, and said mouth guard includes a labial shield embedded in the forward portion of the outer flange and joined to the rear shields and said bridge is a first bridge, and said mouth guard includes a second bridge, the second bridge being attached to the rear shields.

20. The mouth guard of claim 19, wherein the second bridge extends at least partly along the forward base portion, and wherein each arm has a longitudinal length, with each rear shield extending at least 50% of the longitudinal length of the respective arm.
